(19) United States
(12) Patent Application Publication
(10) Pub. No.: US 2015/0153179 A1
(43) Pub. Date: Jun. 4, 2015

(54) TOUCH-SENSITIVE NAVIGATION AID DEVICE

(71) Applicant: Commissariat a I'energie atomique et aux ene alt, Paris (FR)

(72) Inventors: Christian Bolzmacher, Montrouge (FR); Margarita Anastassova, Nozay (FR); Moustapha Hafez, Arcueil (FR); Saranya Sivacoumarane, Sceaux (FR)

(73) Assignee: Commissariat a I'energie atomique et aux ene alt, Paris (FR)

(21) Appl. No.: 14/412,610

(22) PCT Filed: Jul. 4, 2013
(86) PCT No.: PCT/FR2013/051588

§ 371 Date: Jan. 2, 2015

(30) Foreign Application Priority Data
Jul. 4, 2012 (FR) 1256394

(51) Int. Cl. G01C 21/20; G06F 3/043; G06F 3/046; G06F 3/041; G06F 1/16; G06F 3/01

(52) U.S. Cl. CPC G01C 21/20; G06F 1/163; G06F 3/016; G06F 3/046; G06F 3/0412; G06F 3/0433

(57) ABSTRACT

This touch-sensitive navigation aid device (10) intended to be worn by a user, comprises:
a touch-sensitive interface (12) having a touch-sensitive contact surface (20),
a plurality of actuators (30) integrated in the touch-sensitive interface (12) and suitable for moving inside the touch-sensitive contact surface (20) so as to render same deformable, and
means (14) for holding the touch-sensitive interface (12) in contact with the user's body designed so that, in the position for holding the touch-sensitive interface (12) in contact with a part of the user's body, the deformable touch-sensitive contact surface (20) is in contact with at least one portion of this part of the body for touch-sensitive stimulation of this portion using the actuators (30),

Furthermore, the movable actuators (30) are arranged according to a two-dimensional arrangement in the deformable touch-sensitive contact surface (20).

The present invention relates to a touch-sensitive navigation aid device. The invention applies more particularly to a touch-sensitive navigation aid device intended to be worn by a user, comprising:
a touch-sensitive interface having a touch-sensitive contact surface,
a plurality of actuators integrated in the touch-sensitive interface and suitable for moving inside the touch-sensitive contact surface so as to render same deformable, and
means for holding the touch-sensitive interface in contact with the user's body designed so that, in the position for holding the touch-sensitive interface in contact with a part of the user's body, the deformable touch-sensitive contact surface is in contact with at least one portion of this part of the body for touch-sensitive stimulation of this portion using the actuators.

Such a device is for example described in the international patent application published under the number WO 2007/105937 A1. More specifically, this device provides a plurality of actuators integrated in a holder intended to be worn by a user around the user's waist. The actuators are particularly positioned linearly on this holder, the latter being closed around the waist such that the actuators are in contact with some points of the user's body, in particular points indicating predefined directions. Various items of touch-sensitive data are then generated by controlling the choice to activate a specific actuator, controlling the frequency and amplitude in respect of vibration of each activated actuator, defining various possible actuator activation sequences, etc. However, according to the target application of this document, each actuator having to indicate a predefined direction, it is essential to design the device on a custom basis for each user and/or provide an elastic holder. This device further has the disadvantage of limiting the quantity of possible actuators since they must remain in contact with specific parts of the user's body and error-free detection by the user of the position of an actuator generating a touch-sensitive signal around the user's waist requires a minimum distance between the actuators. Consequently, as the actuators are further arranged linearly on the holder thereof, this device has the drawback of limiting the variety of messages that may be generated. Finally, the type of holder required (a belt, or any other holder such as a T-shirt or a jacket or a pair of trousers, enabling the actuators to surround the user's waist) has the drawback of being necessarily bulky.

It may thus be sought to provide a touch-sensitive navigation aid device intended to be worn by a user making it possible to do away with at least some of the problems and constraints mentioned above.

The invention thus relates to a touch-sensitive navigation aid device intended to be worn by a user, comprising:
a touch-sensitive interface having a touch-sensitive contact surface,
a plurality of actuators integrated in the touch-sensitive interface and suitable for moving inside the touch-sensitive contact surface so as to render same deformable, and
means for holding the touch-sensitive interface in contact with the user's body designed so that, in the position for holding the touch-sensitive interface in contact with a part of the user's body, the deformable touch-sensitive contact surface is in contact with at least one portion of this part of the body for touch-sensitive stimulation of this portion using the actuators, wherein the movable actuators are arranged according to a two-dimensional arrangement in the deformable touch-sensitive contact surface.

In this way, arranging the actuators in a two-dimensional arrangement in the deformable touch-sensitive contact surface makes it possible to provide data of the degree of richness sought, regardless of the manner wherein the touch-sensitive interface is kept in contact with the user's body. Consequently, it is possible to envisage various types of holders, particularly less bulky holders such as belts, T-shirts, jackets or others. The parts of the user's body to be used may also be very varied, particularly other than the user's waist, in particular parts of the body more sensitive to touch-sensitive stimulation. Furthermore, the arrangement of the actuators and the number thereof on the holder is less limited, making it possible to increase the diversity of the data to be transmitted.

Optionally, the movable actuators are distributed in a circular or elliptical manner in the deformable touch-sensitive contact surface.

Also optionally, a touch-sensitive navigation aid device according to the invention may comprise at least eight movable actuators distributed in the deformable contact surface so as to indicate at least the eight cardinal and intercardinal directions.

Also optionally, the movable actuators are distributed in a regular two-dimensional fashion, particularly in a matrix fashion, in the deformable touch-sensitive contact surface.

Also optionally, the touch-sensitive interface comprises an elastic flexible membrane extending against the deformable touch-sensitive contact surface, this elastic flexible membrane being deformable according to the movements of the actuators.

Also optionally, the touch-sensitive interface comprises a perforated part extending in the deformable touch-sensitive contact surface, the holes of this part being arranged facing the movable actuators and traversed by ends of these movable actuators, these ends acting as touch-sensitive contacts stimulated according to the movements of the actuators.

Also optionally, the touch-sensitive interface comprises electromagnetic means for activating the movable actuators, these electromagnetic means comprising:
a monolithic flexible structure comprising a plurality of deformable beams, each deformable beam having a free end whereon an actuator in the form of a touch-sensitive block is positioned,
a plurality of electromagnetic coils, actuating the deformable beams as a function of currents traversing said coils and thus selectively moving the touch-sensitive blocks in the deformable touch-sensitive contact surface to produce a touch-sensitive sensation.

Also optionally, the touch-sensitive interface comprises piezoelectric means for activating the movable actuators, these piezoelectric means comprising:
a monolithic flexible structure comprising a plurality of deformable beams, each deformable beam having a piezoelectric portion and a free end whereon an actuator in the form of a touch-sensitive block is positioned,
means for the selective application of voltages on the piezoelectric portions of the deformable beams, thus actuating the deformable beams and selectively moving the touch-sensitive blocks in the deformable touch-sensitive contact surface to produce a touch-sensitive sensation.

Also optionally, the touch-sensitive interface comprises piezoelectric means for activating the movable actuators, these piezoelectric means comprising:
a monolithic flexible structure comprising a plurality of deformable beams, each deformable beam being made of a piezoelectric material covered by electrodes and having a free end whereon an actuator in the form of a touch-sensitive block is positioned,
means for the selective application of voltages, via the electrodes, on each deformable beam made of piezoelectric material, thus actuating the deformable beams and selectively moving the touch-sensitive blocks in the deformable touch-sensitive contact surface to produce a touch-sensitive sensation.

Also optionally, the touch-sensitive interface further has, opposite the deformable touch-sensitive contact surface, a visible face comprising a light display system, particularly a plurality of light-emitting diodes distributed on the visible face facing the movable actuators, each diode being activated according to a movement of the corresponding actuator.

Also optionally, the touch-sensitive interface comprises a housing and the holding means comprise a strap connected to the housing, lockable around a user's arm, for keeping the housing in contact with the user's arm.

Also optionally, a touch-sensitive navigation aid device according to the invention may further comprise at least one positioning sensor chosen in the set consisting of an inertial system, a gyrometer, an accelerometer and a magnetometer, to determine the position and orientation of the touch-sensitive device in space. The invention will be understood more clearly using the description hereinafter, given merely by way of example and with reference to the appended figures wherein:

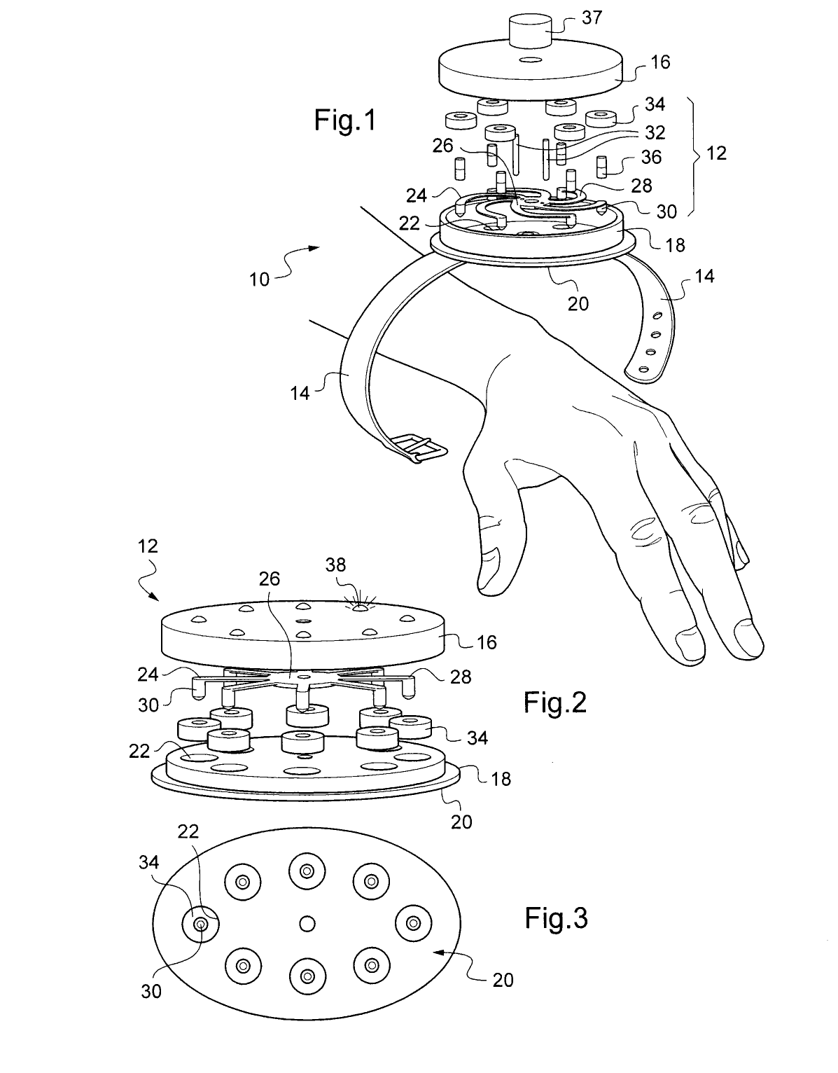

FIG. 1 represents schematically an exploded perspective view of the general structure of a touch-sensitive navigation aid device according to a first embodiment of the invention,

FIG. 2 represents schematically an exploded perspective view of the general structure of a touch-sensitive interface of a touch-sensitive navigation aid device according to a second embodiment of the invention,

FIG. 3 represents schematically a front view of a deformable touch-sensitive contact surface of the touch-sensitive interface in FIG. 2,

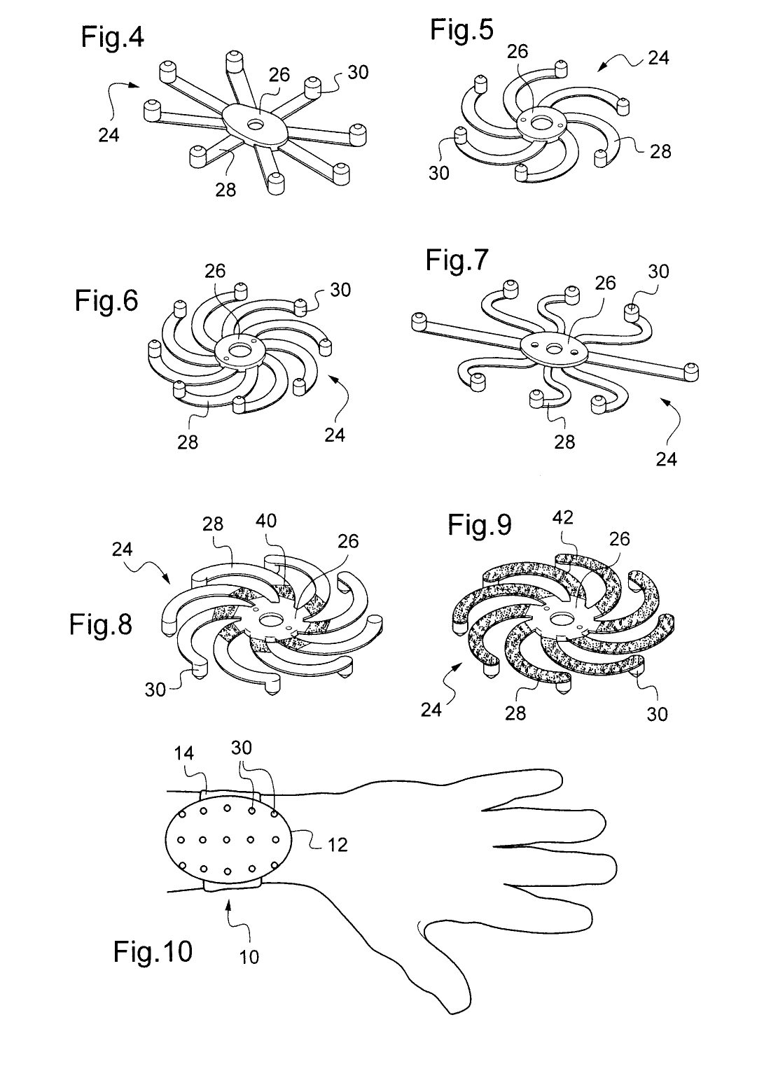

FIGS. 4 to 9 represent schematically perspective views of various alternative embodiments of flexible actuator activation structures for a touch-sensitive navigation aid device according to the invention, and

FIG. 10 represents schematically a top view of a touch-sensitive navigation aid device worn by a user, according to a third embodiment of the invention.

A touch-sensitive navigation aid device 10, according to a first embodiment of the invention, is represented in an exploded perspective view in FIG. 1. This device comprises a touch-sensitive interface 12 and means 14 for holding the touch-sensitive interface 12 in contact with the user's body. The touch-sensitive interface 12 comprises a housing of any shape, for example circular according to the example in FIG. 1, consisting of an upper frame 16 and a lower frame 18 interlocking into each other and suitable for being attached to each other by well-known means not shown. The surface external to the housing of the lower frame 18 forms a touch-sensitive contact surface 20 of the touch-sensitive interface 12 of the touch-sensitive device 10. The lower frame 18 is further perforated with cylindrical holes 22 distributed in a two-dimensional fashion, for example regularly, and extending into the space occupied by the touch-sensitive contact surface 20.

Between the two frames 16 and 18, in other words inside the housing, a volume is available to receive a plurality of movable electromagnetic actuators and electromagnetic means for activating these actuators.

The electromagnetic activation means comprise a monolithic flexible structure 24 generally consisting of a soft or hard ferromagnetic material. The monolithic flexible structure 24 comprises, at the center thereof, a ring 26, fixed with respect to the housing and centered in the inner volume of the housing, from which a plurality of deformable beams 28 extend laterally. In the example in FIG. 1, six deformable beams are illustrated, but generally at least three or four deformable beams should be provided according to the invention. Each deformable beam 28 has a first end rigidly connected to the fixed ring 26 and a second free end whereon a movable actuator adopting the form of a touch-sensitive block 30 is positioned. Each touch-sensitive block 30 is positioned facing each of the cylindrical holes 22 of the lower frame 18 and consequently the touch-sensitive blocks 30 are distributed two-dimensionally. The flexible structure 24 is attached between the upper frame 16 and lower frame 18 of the housing using two rigid cylindrical rods 32 extending through two holes formed in the fixed ring 26.

In order to cause the deformation of the six beams 28 of the flexible structure 24 and consequently a movement of the free ends thereof carrying the touch-sensitive blocks 30, the electromagnetic activation means further comprise a plurality of coils 34 and magnets 36. Each magnet 36 is cylindrical and positioned against each touch-sensitive block 30 on the flexible structure 24. Each coil 34 is annular, arranged about each magnet 36 and individually controlled by an electrical current source (not shown) for the selective movement of each magnet 36 which, positioned against the respective touch-sensitive block 30, moves same by deforming the flexible structure 24. In this way, the touch-sensitive blocks 30 actuated are moved through the cylindrical holes 22 of the lower frame 18 so as to traverse the touch-sensitive contact surface 20 rendering said surface deformable.

Each touch-sensitive block 30 may be moved according to a vibratory mode or a pressure mode.

In vibratory mode, the touch-sensitive blocks 30 are moved in the cylindrical holes 22 according to a periodic to-and-fro movement at an oscillation frequency that may be adjusted, ideally between 0 and 300 Hz. Skin, particularly in the wrist region, is very sensitive around 250 Hz, but this frequency has the drawback of being acoustically unpleasant and of producing an unpleasant tactile sensation. In order to remedy this drawback, it is advantageous to use a lower oscillation frequency, particularly between 10 and 100 Hz, where the vibrations are no longer audible while the skin still remains sensitive.

In such an embodiment with electromagnetic activation of the movable actuators, when any one of the coils 34 is subjected to a sinusoidal voltage, the corresponding magnet 36 moves inside the coil 34 transmitting the vibration to the corresponding touch-sensitive block 30. The frequency of the periodic excitation to which each coil 34 is subjected should be close to the natural frequency of each beam 28.

In pressure mode, each touch-sensitive block 30 for which the movement is activated is held in an inserted position wherein it passes through the touch-sensitive contact surface 20 while deforming same. In such an embodiment with electromagnetic activation of the movable actuators, when the coil 34 is subjected to a direct voltage, the corresponding touch-sensitive block 30 is moved and held in position by pressing the corresponding magnet 26 against the deformable structure 24 while the electrical current is applied. The amplitude of the movement may be adjusted using the direct voltage value applied.

According to the alternative embodiment illustrated in FIG. 1, the touch-sensitive interface 12 is positioned above a user's wrist. The means 14 for holding the touch-sensitive interface 12 in contact with the user's body are then more specifically holding means 14 about the wrist, for example a watch strap 14 closed around the user's wrist such that the deformable touch-sensitive contact surface 20 is in contact with at least one portion of the wrist for a touch-sensitive stimulation of this portion using the touch-sensitive blocks 30. However, as a general rule, different types of holders for holding the touch-sensitive device 10 in contact with the different parts of the user's body may be envisaged.

The touch-sensitive navigation aid device 10 is intended to use the user's touch sensitivity to transmit data to the user. According to the invention, the movable actuators, i.e. the touch-sensitive blocks 30, are distributed two-dimensionally in the deformable touch-sensitive contact surface 20 making it possible to display a wide range of touch-sensitive patterns on the deformable touch-sensitive surface 20. By way of example, the touch-sensitive interface 12 in FIG. 1 comprises six movable actuators distributed in a circular or elliptical manner at the six angles of a hexagon in the deformable touch-sensitive contact surface 20.

Alternatively and as illustrated for example in FIGS. 2 and 3, eight movable actuators may be distributed regularly in a circular or elliptical manner in the deformable contact surface 20 thus making it possible to indicate at least the following eight cardinal and intercardinal directions: “North”, “North-East”, “East”, “South-East”, “South”, “South-West”, “West” and “North-West”.

The messages to be transmitted by such a device may also result from a sequence of predefined activated touch-sensitive block configurations, a configuration being characterized by a specific number of activated actuators placed on particular positions.

In this way, according to the alternative embodiment mentioned above for indicating the eight cardinal and intercardinal directions, and by way of non-limiting example, a simple message for indicating a cardinal direction could be formulated by a single activated actuator. On the other hand, a more complex message such as “turn right” could be formulated by the sequential activation (in vibratory or pressure mode) of a plurality of actuators, for example the actuators successively indicating the cardinal directions, “North”, “North-East”, “East”, “South-East”, “South”, “South-West”, “West” and “North-West”.

Furthermore, for each actuator activated, various parameters, for example the vibration frequency, the vibration amplitude, the activation time and duration, etc., may be modified. The variation of the value of one or a plurality of these parameters makes it possible to generate different messages while using the same configuration and consequently increase the diversity of the messages that can be transmitted. These variations also make it possible to transmit more abstract messages. By way of example, any message expressed by a predefined stimulated actuator configuration could be enriched with a danger concept by increasing the vibration frequency and amplitude of the actuators at the same time.

As a general rule, the touch-sensitive device 10 may further be connected to a mobile device (not illustrated) comprising:
a receiving circuit capable of receiving positioning data from satellite or terrestrial beacons and of deducing the geographic position of the receiver therefrom,
a processor equipped with a navigation software module, for example suitable for computing an optimal path in relation to a destination recorded by the user, and a software module capable of translating each navigation instruction of the optimal path into a sequence of touch-sensitive messages.

This mobile device, for example a mobile telephone or a PDA, transmits touch-sensitive messages to the touch-sensitive device 10 via a network. This network is for example a local Bluetooth (registered trademark) type network.

Each touch-sensitive message received by the touch-sensitive device 10 has a corresponding series of electrical signals, to be sent to each of the coils 34. A control circuit (not shown in the figures) selectively transmits the currents in the various coils. This control circuit may be located in the touch-sensitive device 10.

Optionally, positioning sensors 37 are positioned in or on the touch-sensitive device 10, for example an inertial system, gyrometers, accelerometers or magnetometers. These sensors generate signals for determining the position and orientation of the actuators in the touch-sensitive interface 12. These signals may then be used to recompute the touch-sensitive messages to be transmitted to the touch-sensitive device 10 accounting for the position of the actuators and the orientation of the touch-sensitive interface 12. The signals generated by the positioning sensors 37 may be transmitted via a network to the abovementioned mobile device and be processed in the processor of this mobile device. However, alternatively, the processing of these signals may also be performed by the touch-sensitive device 10 if said device comprises the computing means required.

As indicated above, FIG. 2 illustrates a second embodiment of the touch-sensitive interface 12 having eight actuators. According to this embodiment, the monolithic flexible structure 24 and the lower frame 18 further both consist of a soft ferromagnetic material. This embodiment uses the same electromagnetic actuator activation principle as above. However, it is differentiated from the previous embodiment in that the touch-sensitive blocks 30 take the place of the magnets 36 and are moved directly by the coils 34 since they are themselves made of soft ferromagnetic material. Consequently, one advantage of this embodiment is the compact design thereof and the lower number of different elements to be provided inside the housing 16, 18. A second advantage of this second embodiment is the absence of magnets which could disturb some sensors of a mobile telephone optionally used for controlling the touch-sensitive device 10.

The lower frame 18 is perforated with eight cylindrical holes 22 positioned facing the eight touch-sensitive blocks 30 and distributed two-dimensionally and regularly on the deformable touch-sensitive contact surface 20 to enable an indication of the eight cardinal and intercardinal directions. The electromagnetic means for activating the actuators comprise eight electromagnet coils 34 arranged in each of the holes 22 of the inner wall of the lower frame 18. It is then seen that a second advantage of this second embodiment is the channeling of the magnetic field generated around each coil 34. This magnetic field thus remains contained inside the housing of the touch-sensitive interface 12, between the flexible structure 24 and the lower frame 18, which are both made of soft ferromagnetic material, thus protecting the signals of the gyrometers or accelerometers optionally positioned in the vicinity of the housing.

Optionally, a touch-sensitive navigation aid device according to the invention may comprise a light display system distributed on the surface external to the housing of the upper frame 16 to generate a visual feedback enhancing the comprehension of the touch-sensitive messages. In particular, as illustrated in FIG. 2 for the second embodiment, but this could also be envisaged in the first embodiment in FIG. 1, light-emitting diodes 38 may be integrated on the outer surface of the upper frame 16 facing each touch-sensitive block 30. Each light-emitting diode 38 is activated according to a movement of the corresponding actuator: for example, a light-emitting diode 38 is lit when the touch-sensitive block 30 stimulates the user's wrist by the movement or vibration thereof.

Also optionally, the touch-sensitive interface 12 may comprise an elastic flexible membrane extending in the deformable touch-sensitive contact surface 20 under the lower frame 18, this elastic flexible membrane being deformable according to the movements of the actuators. This flexible membrane then fulfils a protection function in respect of the elements arranged inside the housing, rendering same impervious.

FIG. 3 illustrates a front view of the deformable touch-sensitive contact surface 20 of the touch-sensitive interface 12 of the second embodiment in FIG. 2. The eight coils 34 surrounding the eight touch-sensitive blocks 30 are visible via the eight holes 22 distributed two-dimensionally in the deformable touch-sensitive contact surface 20 having an elliptical shape in this figure. Obviously, different shapes of the deformable touch-sensitive contact surface 20 and a different number of cylindrical holes 22 could be envisaged.

Various possible shapes and arrangements of the beams 28 of the flexible structure 24 described above will now be detailed according to the alternative embodiments illustrated in FIGS. 4 to 7.

According to the alternative embodiment illustrated in FIG. 4 corresponding to the configuration of the second embodiment in FIG. 2, the flexible structure 24 has an elliptical shape and comprises a fixed ring 26 and eight straight deformable beams 28 extending laterally regularly about the fixed ring 26. The advantage of the elliptical shape in relation to a circular shape is the ergonomics thereof for a better fit on the user's wrist.

According to the alternative embodiment illustrated in FIG. 5 corresponding to the configuration of the first embodiment in FIG. 1, the flexible structure 24 has a circular shape and comprises a fixed ring 26 and six deformable beams 28 extending laterally in a regular fashion around the fixed ring 26. However, in this alternative embodiment, the deformable beams 28 of identical size are presented in a curved shape, for example semi-circular. The curved shape of the beams 28 has the advantage of being able to increase the length thereof without requiring or needing to increase the outer diameter of the flexible structure 24. Increasing the length of the beams 28 makes it possible to decrease the resonance frequency of said beams and achieve the sought frequency range, i.e. approximately 50 Hz. This aim is thus achieved without any negative effect in respect of size.

The third alternative embodiment illustrated in FIG. 6 only differs from the previous embodiment by the number of deformable beams 28 in the flexible structure 24: there are eight instead of six.

Obviously, intermediate alternative embodiments between the first alternative embodiment illustrated in FIG. 4 and the second and third alternative embodiments illustrated in FIGS. 5 and 6 may be envisaged. In particular, one alternative embodiment whereby the elliptical flexible structure would have curved deformable beams.

Finally FIG. 7 illustrates a fourth alternative embodiment of an elliptical flexible structure 24 with eight deformable beams 28 arranged regularly around the rings 22 and having the same length. The deformable beams 28 are presented in different shapes. In this way, the two beams 28 positioned in the direction of the major axis of the ellipse are straight, whereas the remaining six beams 28 have a curved shape, for example a partial “S” shape, for increasing the length of these six beams 28 (so that it is equal to that of the two straight beams) without increasing the size of the elliptical shape.

FIGS. 8 and 9 schematically represent a perspective view of two alternative embodiments of flexible structures 24 according to one embodiment wherein the electromagnetic actuator activation means are replaced by piezoelectric means for bending the deformable beams 28. These piezoelectric means use the deformation induced by an electrical voltage to selectively induce a deformation of the deformable beams 28 and thus a movement of the actuators (i.e. the touch-sensitive blocks 30). The general principle is that if a voltage applied to an element made of piezoelectric material has the same polarity as this element, the latter is deformed by compression. If, on the other hand, the polarity of the voltage is the reverse of that of the material, said material is deformed by extension.

According to the alternative embodiment of a flexible structure illustrated in FIG. 8, a piezoelectric ceramic strip 40 is attached to each deformable beam 28 of the flexible structure 24, so as to only cover a portion, close to the end rigidly connected to the fixed ring 26, of each deformable beam 28. A sinusoidal alternating electrical voltage, wherein the frequency corresponds to the natural oscillation frequency of each deformable beam 28, may be applied individually to each piezoelectric ceramic strip 40. The strip is compressed or extended in proportion to the voltage applied. The deformable beams 28 of the flexible structure 24, not varying in length, thus accompany this deformation of the piezoelectric ceramic strip 40 thereof by flexion in proportion to the voltage applied. One drawback of this configuration is that the touch-sensitive blocks 30 can only in practice be actuated in vibratory mode.

One solution for remedying this drawback is illustrated in FIG. 9. According to this alternative embodiment of a flexible structure 24, a piezoelectric ceramic strip 42 is attached to each deformable beam 28 of the flexible structure 24, on a markedly larger portion extending from the fixed ring 26 to the free end of the deformable beam 28. In vibratory mode, the free end is then moved on either side of the idle position thereof, under the effect of a sinusoidal electrical voltage applied to the piezoelectric ceramic strip 42 and so as to deform same by compression or by extension. The frequency of the electrical signal applied to each deformable beam 28 corresponds to the resonance frequency of this beam 28. However, as indicated above, the particular benefit of this alternative embodiment is that the deformable beams 28 may be stimulated in pressure mode. In this way, a direct electrical voltage may be applied to any of the deformable beams 28, causing the movement of the corresponding block 30 via the deformable touch-sensitive contact surface 20, this position being held while the electrical voltage is applied.

A further solution, functionally equivalent, to the previous one, would consist of making each deformable beam 28 of the flexible structure 24 from “piezo bender” type piezoelectric material 42. According to this alternative embodiment of a flexible structure 24, electrodes are attached to each deformable beam 28 made of piezoelectric material 42.

According to a third embodiment represented in a top view in FIG. 10, the actuators or touch-sensitive blocks 30 are arranged in a matrix fashion in the touch-sensitive device 10. This matrix arrangement makes it possible to enrich the number of possible patterns and increase the various types of touch-sensitive messages to be transmitted to the user, particularly by increasing the number of actuators. In the example in FIG. 10, the touch-sensitive interface 12 is attached by a watch strap 14 onto a user's wrist. According to this embodiment, the device has an elliptical shape which is best suited to the shape of the user's arm at the user's wrist, the major axis of the ellipse being arranged lengthwise on the longitudinal axis of the user's arm.

It is obvious that a touch-sensitive navigation aid device such as that described above according to a plurality of embodiments makes it possible to transmit touch-sensitive messages that are as rich in respect of content as desired without a restrictive limitation of the number of actuators suitable for being implemented and with multiple arrangement possibilities around parts of the user's body in contact with the device. This device may indeed be positioned at various locations of the user's body and may use compact holding means, particularly less bulky than a belt, T-shirt, jacket or other means.

It should further be noted that the invention is not limited to the embodiments described above. Indeed, it will be obvious to those skilled in the art that various modifications may be made to the embodiments described above, in the light of the teaching described herein. In the claims hereinafter, the terms used should not be interpreted as limiting the claims to the embodiments disclosed in the present description, but should be interpreted to include therein any equivalents intended to be covered by the claims due to the wording thereof and which can be envisaged by those skilled in the art by applying general knowledge to the implementation of the teaching disclosed herein.

1. A touch-sensitive navigation aid device (10) intended to be worn by a user, comprising:
a touch-sensitive interface (12) having a touch-sensitive contact surface (20),
a plurality of actuators (30) integrated in the touch-sensitive interface (12) and suitable for moving inside the touch-sensitive contact surface (20) so as to render same deformable, and
means (14) for holding the touch-sensitive interface (12) in contact with the user's body designed so that, in the position for holding the touch-sensitive interface (12) in contact with a part of the user's body, the deformable touch-sensitive contact surface (20) is in contact with at least one portion of this part of the body for touch-sensitive stimulation of this portion using the actuators (30),
characterized in that:
the movable actuators (30) are arranged according to a two-dimensional arrangement in the deformable touch-sensitive contact surface (20).

2. The touch-sensitive navigation aid device (10) according to claim 1, wherein the movable actuators (30) are distributed in a circular or elliptical manner in the deformable touch-sensitive contact surface (20).

3. The touch-sensitive navigation aid device (10) according to claim 1, comprising at least eight movable actuators (30) distributed in the deformable contact surface (20) so as to indicate at least the eight cardinal and intercardinal directions.

4. The touch-sensitive navigation aid device (10) according to claim 1, wherein the movable actuators (30) are distributed in a regular two-dimensional fashion, particularly in a matrix fashion, in the deformable touch-sensitive contact surface (20).

5. The touch-sensitive navigation aid device (10) according to claim 1, wherein the touch-sensitive interface (12) comprises an elastic flexible membrane extending against the deformable touch-sensitive contact surface (20), this elastic flexible membrane being deformable according to the movements of the actuators (30).

6. The touch-sensitive navigation aid device (10) according to claim 1, wherein the touch-sensitive interface (12) comprises a perforated part (18) extending in the deformable touch-sensitive contact surface (20), the holes (22) of this part (18) being arranged facing the movable actuators (30) and traversed by ends of these movable actuators, these ends acting as touch-sensitive contacts stimulated according to the movements of the actuators (30).

7. The touch-sensitive navigation aid device (10) according to claim 1, wherein the touch-sensitive interface (12) comprises electromagnetic means (24, 34, 36) for activating the movable actuators (30), these electromagnetic means comprising:
a monolithic flexible structure (24) comprising a plurality of deformable beams (28), each deformable beam (28) having a free end whereon an actuator in the form of a touch-sensitive block (30) is positioned,
a plurality of electromagnetic coils (34), actuating the deformable beams (28) as a function of currents traversing said coils and thus selectively moving the touch-sensitive blocks (30) in the deformable touch-sensitive contact surface (20) to produce a touch-sensitive sensation.

8. The touch-sensitive navigation aid device (10) according to claim 1, wherein the touch-sensitive interface (12) comprises piezoelectric means (24, 40; 24, 42) for activating the movable actuators (30), these piezoelectric means comprising:
a monolithic flexible structure (24) comprising a plurality of deformable beams (28), each deformable beam (28) having a piezoelectric portion (40; 42) and a free end whereon an actuator in the form of a touch-sensitive block (30) is positioned,
means for the selective application of voltages on the piezoelectric portions (40; 42) of the deformable beams (28), thus actuating the deformable beams (28) and selectively moving the touch-sensitive blocks (30) in the deformable touch-sensitive contact surface (20) to produce a touch-sensitive sensation.

9. The touch-sensitive navigation aid device (10) according to claim 1, wherein the touch-sensitive interface (12) comprises piezoelectric means (24, 42) for activating the movable actuators (30), these piezoelectric means comprising:
a monolithic flexible structure (24) comprising a plurality of deformable beams (28), each deformable beam (28) being made of a piezoelectric material (42) covered by electrodes and having a free end whereon an actuator in the form of a touch-sensitive block (30) is positioned,
means for the selective application of voltages, via the electrodes, on each deformable beam (28) made of piezoelectric material (42), thus actuating the deformable beams (28) and selectively moving the touch-sensitive blocks (30) in the deformable touch-sensitive contact surface (20) to produce a touch-sensitive sensation.

10. The touch-sensitive navigation aid device (10) according to claim 1, wherein the touch-sensitive interface (12) further has, opposite the deformable touch-sensitive contact surface (20), a visible face comprising a light display system, particularly a plurality of light-emitting diodes (38) distributed on the visible face facing the movable actuators (30), each diode (38) being activated according to a movement of the corresponding actuator (30).

11. The touch-sensitive navigation aid device (10) according to claim 1, wherein the touch-sensitive interface (12) comprises a housing (16, 18) and the holding means (14) comprise a strap connected to the housing (16, 18), lockable around a user's arm, for keeping the housing (16, 18) in contact with the user's arm.

12. The touch-sensitive navigation aid device (10) according to claim 1, further comprising at least one positioning sensor (37) chosen in the set consisting of an inertial system, a gyrometer, an accelerometer and a magnetometer, to determine the position and orientation of the touch-sensitive device (10) in space.
